(19) United States
(12) Patent Application Publication
(10) Pub. No.: US 2003/0011673 A1
(43) Pub. Date: Jan. 16, 2003

(54) Device for protecting a user's eyes in metal welding or cutting

(76) Inventor: Ingemar Eriksson, Dala-Floda (SE)

Correspondence Address: Rolf Fasth, Fasth Law Office, 189 Curtis Drive, Longview, WA, 98632-5374, US

(21) Appl. No.: 10/203,700

(22) PCT Filed: Feb. 8, 2001
(86) PCT No.: PCT/SE01/00237

(30) Foreign Application Priority Data
Feb. 11, 2000 (SE) 0000428-3

(51) Int. Cl. H04N 13/00

(52) U.S. Cl. 348/42; 348/51; 348/90

(57) ABSTRACT

The invention relates to a device for protecting a user's eyes in metal welding or cutting, comprising a shielding element (1) which allows visual monitoring of the working process but protects the user's eyes from light radiation. The device comprises a video camera (5) which is detectable towards the place of working for recording the working process in the form of video signals transmitted to a video display unit (7) placed in the shielding element (1).

The present invention relates to a device for protecting a user's eyes in metal welding or cutting, comprising a shielding element which allows visual monitoring of the working process but protects the user's yes from light radiation.

### BACKGROUND OF THE INVENTION

In welding and thermal cutting of metal, very powerful radiation is emitted, on the one hand, in the form of light radiation within the visible spectrum and, on the other, in the form of ultraviolet as well as infrared radiation. Such radiation is extremely injurious to the eyes and an operator must protect his eyes carefully when performing such work.

One problem when designing eye-protecting devices for welding is that the light radiation cannot be completely excluded since the operator must be able to visually monitor the working process.

The most common eye-protecting device in welding is the type that comprises a dark glass or filter glass which is arranged in spectacles, a shield, a mask, a visor or the like and during welding the filter glass is placed before the eyes. One problem of such filter glass is that it is substantially non-transparent in case of normal light intensity and only the very intense light that arises in welding can pass through. Thus, before starting welding and in case of interruptions in the welding operation, the operator can hardly see anything of the workpiece through the filter glass. For the operator to be able to orientate himself and see where on the workpiece he is supposed to weld, the protective glass is of the flip-up type, and not until the operator has started welding does he flip down the protective glass before his eyes. Besides the fact that the flipping-down of the protective glass can be inconvenient and at least temporarily draw the attention away from the actual welding operation, it also means that the eyes are completely unprotected each time a new welding operation is initiated and the eyes are exposed to the harmful effect of the radiation.

Another common type of eye-protecting device comprises a glass controlled by photocells which is composed of liquid crystals and which becomes dark and automatically dampens the light that passes through the glass when the welding starts. Under normal light conditions before and after welding, the glass is approximately as transparent as ordinary sunglasses. As a result, the protective glass does not have to be flipped down and up during and after welding, respectively. However, the glass exhibits some degree of inertia and when starting welding there is a certain delay before the glass darkens. As a consequence, the most serious problem remains to be solved, i.e. that the eyes are momentarily almost completely unprotected from radiation, which besides the fact that it can be dazzling and very annoying can be harmful to the eyes in case of long exposure.

### SUMMARY OF THE INVENTION

The present invention aims at obviating the drawbacks and disadvantages of prior-art eye-protecting devices for welding and thermal cutting of metal and providing an eye-protecting device which allows visual monitoring of the working zone which is to be welded before as well as during and after welding and which continuously and without interruption is capable of protecting the eyes from harmful radiation. At least these aims are achieved by means of a device according to claim 1.

The invention is thus based on the understanding that the above-mentioned aims can be achieved by using a video camera which transmits images of the working zone in the form of video signals to a video display unit placed before the user's eyes. This guarantees that the maximum radiation intensity which can reach the eyes is limited to the level that can maximally be displayed by the video display unit, but the device can also be used for visual monitoring under normal light conditions when no welding is being performed.

To achieve this, some kind of automatic light-adjusting device, either mechanical or electronic, is required, which automatically limits the light intensity when starting to weld and increases the same again after each completed welding operation.

As a rule, the protective device preferably comprises some type of shield or visor which covers the user's entire face, because some types of welding light contains ultraviolet radiation which can cause burn injuries to the skin like a sun tan. Other types of welding radiation, as well as the radiation that arises in gas cutting, can be considerably less harmful and in these cases a protection of only the eyes may be sufficient.

The video display unit can be designed in many different ways. Since the near point of the adult eye, i.e. the nearest point on which the eyes can focus, is situated about 15-25 cm before the eyes, it can be inappropriate to place a display immediately before the eyes. Such a device would be relatively unwieldy as the display must be placed at a long distance from the eyes and the device would thus take up a great deal of space in the direction away from the face. Instead the representation of the working zone is preferably viewed through some form of magnifying prism or lens/lens system in which the actual physical image of the working zone can be situated at an arbitrary place, besides in the area in front of the eyes, for instance also in the area above or at the side of the head. The actual imaging can be effected in optional manner, for instance on an LCD or by projection from small projectors onto a light-reflecting screen, and the user can view this image via the magnifying prism/lens system.

The device can optionally comprise one video camera or alternatively two or more video cameras to allow stereoscopy. In the last-mentioned case, the image transmissions from the respective video cameras are kept separate so that one eye only sees the image from one video camera and vice versa. Stereoscopy can also be provided by electronic synchronisation and/or sequential imaging in turn by means of each video camera, which requires only one video display unit.

In a preferred embodiment, one video camera, or two in case of stereoscopy, can be detachable from the rest of the device. This may be very advantageous if welding is to be performed in places where it is difficult to see the zone which is to be welded, for instance in narrow spaces. In this case, one or two video cameras can easily be advanced and mounted in the working zone while the operator is positioned at a distance from the working zone and, for instance, stretches out his arm with the welding holder into the space. Moreover, the video camera can be self-acting so that it is automatically directed towards the weld irrespective of how the user holds his head. The control can also be effected, for instance, by detection of and centring on the welding flame.

A device according to the invention can be improved by other arbitrary functions, if desired. Besides being in communication with the video display unit, the video camera or cameras can, for instance, also be in communication with some kind of video storing unit, such as a videotape recorder or CD/DVD player, for documentation and storage of the performance of the welding. This transmission of the video signals to the video storing unit can be provided in an optional manner, such as via a cable or by wireless transmission. In such a video storing unit, it is also possible to store documentation of checks on weld joints, for instance controls of leakage and cracking such as X-ray and ultrasonic testing.

Furthermore, an inventive device can comprise or be connected to an image processing unit which can process the image generated by the video camera in different ways so that different parameters which are important to the working process become visible or are illustrated as the operation proceeds and can also be stored in the video storing unit. Such process parameters may involve, for instance the temperature, on the one hand, in the actual welding zone and, on the other hand, in the surrounding material. Image processing also makes it possible to remove welding fumes from the image which block the view. Such measurement and registration of temperature can be effected, for instance, by sensors in the video camera and reproduced by areas with different temperatures being coloured differently in the image viewed by the operator. The process parameters can also be reproduced in the form of numerical data or diagrams beside the actual video image.

The device is primarily intended to be physically carried by the user in the form of a helmet or some other gear on his head, possibly except the video storing unit and image processing unit, if present, which can advantageously be arranged at a distance from the user. However, it would also be feasible to attach the device to an adjustable arm at a workbench or the like.

### BRIEF DESCRIPTION OF THE ACCOMPANYING DRAWINGS

In the drawings

FIG. 1 is a perspective view of a person who is welding and is equipped with an eye-protecting device according to the present invention;

FIG. 2 is a side view of the person with the eye-protecting device partly in cross-section;

FIG. 3 is an example of a video image which the user can see during welding; and

FIG. 4 is a second example of a video image which the user could see.

### DETAILED DESCRIPTION OF A PREFERRED EMBODIMENT OF THE INVENTION

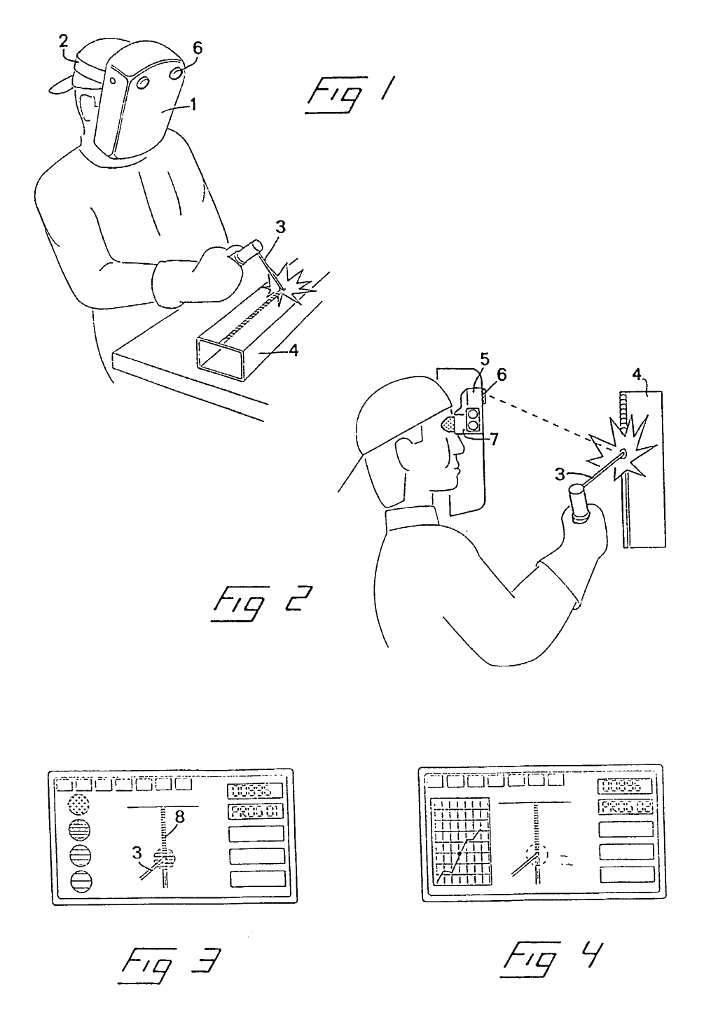

One example of an embodiment of the invention will now be described with reference to the accompanying drawings. FIGS. 1 and 2 illustrate a user who is welding and who has an eye-protecting device according to the present invention. In this embodiment, the eye-protecting device is designed as a visor or a shield 1, which covers the user's entire face and is retained in place by a cord 2 around the user's head. Reference numeral 3 designates a welding holder and a welding electrode which are used when welding on a workpiece 4.

The shown eye-protecting device comprises two video cameras 5 of which two lenses 6 are visible from the outside of the shield. In FIG. 2, the shield is shown partly in cross-section to illustrate in more detail the construction of the eye-protecting device. The light which is caught by the respective lenses 6 is converted in the video camera unit 5 into signals which are transmitted to a video display unit 7 to generate a video image which the user can see via a lens system (not shown). The shown eye-protecting device comprises two video camera units and two video display units for generating a right-hand and a left-hand image, which can be viewed by the user's respective eyes, thus resulting in a stereo image with the possibility of visual depth.

FIGS. 3 and 4 illustrate examples of various conceivable images which can be viewed by means of the eye-protecting device if the video camera is connected to image processing equipment. In the centre of the image, the actual working zone is shown with the welding electrode 3 and the weld joint 8 which is being made. On each side of the actual working zone, various types of information are illustrated which can be retrieved from the video recording by suitable image processing. FIG. 3 is intended to show the variation in temperature in the weld joint and the surrounding material by areas with different temperatures being differently coloured. The temperature value of the respective colours can suitably be indicated in the video image, as suggested, by different screen patterns to the left in FIG. 3. In case of too high or too low a welding temperature, the operator can easily change the settings of the welding assembly. Such a change of the settings of the welding assembly may also be performed by remote control via the video equipment, for instance, by means of control buttons on the video equipment or by voice control effected by the operator. The image processing is not limited to the measurement of temperature but many other functions can be integrated into the system and presented to the user in various optional views. FIG. 4 illustrates such an alternative view in which a chart, instead of colours, is shown for an important parameter, for instance, the variation in time of the temperature or welding voltage.

The image processing equipment, which preferably comprises a microprocessor, can be built into the actual video unit so that the entire equipment is carried by the user in a shield, helmet or the like. However, as previously mentioned, the video unit can be connected to an isolated unit, wirelessly or via a cable, which for instance contains an image processing and video storing unit. With the aid of equipment of the latter type, it is also possible for an instructor to closely follow a pupil's welding operation during training and/or welding certification and give him instructions as the work proceeds, for instance, in the form of text messages on the video screen or voice messages via a loudspeaker/headset.

1. A device for protecting a user's eyes in metal welding or cutting, comprising a shielding element (1) which allows visual monitoring of the working process but protects the user's eyes from light radiation, characterised in that it comprises a video camera (5) which is directable towards the place of working for recording the working process in the form of video signals transmitted to a video display unit (7) which the user is able to view and which is placed in the shielding element (1).

2. A device as claimed in claim 1, characterised in that the video display unit (7) comprises a magnifying prism, a lens or a lens system before each eye.

3. A device as claimed in claim 1 or 2, characterised in that it comprises two video cameras (5) and one or two video display units (7) for stereoscopy.

4. A device as claimed in any one of the preceding claims, characterised in that at least one video camera (5) is detachable from the shielding element to facilitate viewing in places which are difficult of access.

5. A device as claimed in any one of the preceding claims, characterised in that the video camera (5) is in communication with a video recording unit.

6. A device as claimed in any one of the preceding claims, characterised in that it is in communication with an image processing unit.

7. A device as claimed in claim 6, characterised in that process parameters from the image processing unit are viewable via the video display unit (7).

8. A device as claimed in any one of the preceding claims, characterised in that the welding equipment is controllable via the shielding element (1).
